(19) United States
(12) Patent Application Publication
(10) Pub. No.: US 2010/0080961 A1
(43) Pub. Date: Apr. 1, 2010

(54) METHOD OF PROCESSING GLASS SUBSTRATE SURFACE

(75) Inventors: Kenji OKAMURA, Tokyo (JP); Masabumi Ito, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: ASAHI GLASS COMPANY, LIMITED, Tokyo (JP)

(21) Appl. No.: 12/631,304

(22) Filed: Dec. 4, 2009

Related U.S. Application Data
(63) Continuation of application No. PCT/JP2008/059758, filed on May 21, 2008.

(30) Foreign Application Priority Data
Jun. 5, 2007 (JP) 2007-148752

(51) Int. Cl. B32B 3/02; B44C 1/22; B29D 11/00

(52) U.S. Cl. 428/192; 216/24; 264/1.37

(57) ABSTRACT

The present invention is to provide a method for processing the whole of a glass substrate surface so as to give a surface excellent in flatness and surface roughness. The present invention provides a method of processing a glass substrate surface using a processing technique selected from the group consisting of ion-beam etching, gas cluster ion-beam etching, plasma etching, and nano-ablation, wherein a frame element satisfying the following (1) and (2) is arranged along the periphery of the glass substrate before the glass substrate surface is processed: (1) the difference between the height of the frame element and the height of the glass substrate surface is 1 mm or smaller; and (2) the frame element has a width which is not smaller than one-half the beam diameter or laser light diameter to be used in the processing technique.

### TECHNICAL FIELD

The present invention relates to a method of processing a glass substrate surface. More particularly, the invention relates to a method of processing a glass substrate surface to give a surface excellent in flatness and surface roughness as in the glass substrates for use in reflective type masks for EUV (extreme ultraviolet) lithography in semiconductor device production steps.

### BACKGROUND ART

In lithographic techniques, an exposure tool for transferring a fine circuit pattern to a wafer to produce an integrated circuit has been used extensively. With the trend toward higher degrees of integration, higher speeds, and higher functions in integrated circuits, integrated circuits are becoming finer. Exposure tools are required to form a circuit pattern image having high resolution on a wafer surface at a long focal depth, and shortening of the wavelength of an exposure light is being advanced. Besides g-line (wavelength, 436 nm), i-line (wavelength, 365 nm), and KrF excimer lasers (wavelength, 248 nm), which have been used as light sources, ArF excimer lasers (wavelength, 193 nm) are coming to be employed as light sources having a further shorter wavelength. Furthermore, use of an F₂ laser (wavelength, 157 nm) is regarded as promising for coping with next-generation integrated circuits having a circuit line width of 100 nm or small. However, even this technique is considered to cover only up to the generation having a line width of 70 nm.

Under these technical circumstances, a lithographic technique employing EUV light as a next-generation exposure light is considered to be applicable to plural generations of the 45-nm and thereafter. The term EUV light means a light having a wavelength in the soft X-ray region or vacuum ultraviolet region, specifically a light having a wavelength of about 0.2-100 nm. At present, use of a lithographic light source of 13.5 nm is being investigated. The exposure principle of this EUV lithography (hereinafter abbreviated to “EUVL”) is equal to that of conventional lithography in that a mask pattern is transferred with an optical projection system. However, a refractive optical system cannot be used because there is no material which is light-transmitting in the EUV light energy region, and a reflective optical system is inevitably used (see patent document 1).

The mask for use in EUVL is constituted basically of (1) a glass substrate, (2) a reflective multilayer film formed on the glass substrate, and (3) an absorber layer formed on the reflective multilayer film. As the reflective multilayer film is used a film having a structure in which two or more materials which differ in refractive index at the wavelength of the exposure light and are periodically superposed one on another at a nanometer scale. Typical known materials are molybdenum and silicon.

For the absorber layer, use of tantalum and chromium is being investigated. Concerning the glass substrate, the material thereof is required to have a low coefficient of thermal expansion so as not to deform even upon irradiation with EUV light, and use of a glass having a low coefficient of thermal expansion or crystallized glass having a low coefficient of thermal expansion is being investigated. In the present specification, the glass having a low coefficient of thermal expansion and the crystallized glass having a low coefficient of thermal expansion are inclusively referred to as “low-expansion glass” or “ultra-low-expansion glass”.

A glass substrate is produced by highly precisely processing such a glass or crystallized-glass material and washing the processed glass. When a glass substrate is to be processed, preliminary polishing is generally conducted at a relatively high processing rate until the glass substrate surface comes to have a predetermined flatness and a predetermined surface roughness. Thereafter, this glass substrate surface is processed so as to result in a desired flatness and desired surface roughness by a method of higher processing accuracy or under processing conditions which result in higher processing accuracy. Examples of the method of high processing accuracy which can be used for this purpose include ion-beam etching, gas cluster ion-beam etching, plasma etching, and nano-ablation with laser light irradiation (see patent document 2 to patent document 5).

Patent Document 1: JP-T-2003-505891

Patent Document 2: JP-A-2002-316835

Patent Document 3: JP-A-8-293483

Patent Document 4: JP-A-2004-291209

Patent Document 5: JP-A-2006-133629

### DISCLOSURE OF THE INVENTION

Methods in which a glass substrate surface is subjected to beam irradiation or laser light irradiation, such as ion-beam etching, gas cluster ion-beam etching, plasma etching or nano-ablation with laser light irradiation, are suitable for processing a glass substrate surface to a desired flatness and a desired surface roughness, because of high processing accuracy and for other reasons.

However, the present inventors found that when those methods in which a glass substrate surface is irradiated with a beam or irradiated with a laser light are used, there is a problem that it is impossible to uniformly process the whole glass substrate. Specifically, there is a difference in processing rate between the peripheral edge neighborhood of the glass substrate and the remaining part of the glass substrate (e.g., a central part of the glass substrate) and the peripheral edge neighborhood is hardly made flat. When it is hard to make the peripheral edge neighborhood flat, the resultant processed glass substrate gives an EUVL mask blank in which the exposure region for patterning is limited to the part other than the peripheral edge neighborhood of the glass substrate. This is not favorable from the standpoint of heightening the degree of integration of integrated circuits.

For overcoming the problems of conventional techniques described above, an object of the invention is to provide a method of processing a glass substrate surface so as to result in a surface excellent in flatness and surface roughness. More specifically, the object is to provide a method for processing the whole surface of a glass substrate into a surface excellent in flatness and surface roughness.

In order to accomplish that object, the invention provides a method of processing a glass substrate surface by a processing technique selected from the group consisting of ion-beam etching, gas cluster ion-beam etching, plasma etching, and nano-ablation,

wherein a frame element satisfying the following requirements (1) and (2) is arranged along the periphery of the glass substrate before the glass substrate surface is processed:

(1) the difference between the height of the frame element and the height of the glass substrate surface is 1 mm or smaller; and

(2) the frame element has a width which is not smaller than one-half the beam diameter or laser light diameter to be used in the processing technique.

In the method of processing a glass substrate surface of the invention, the glass substrate is preferably made of a low-expansion glass having a coefficient of thermal expansion at 20° C. or at 50-80° C. of from −30 to 30 ppb/° C.

It is preferred that the frame element is made of the same glass material as the glass substrate to be processed.

It is preferred that the frame element is made of any member selected from the group consisting of a polyimide, an Ni—Cr alloy, beryllium, and single-crystal sapphire, or that the frame element has a surface coated or plated with any member selected from said group.

In the method of processing a glass substrate surface of the invention, the glass substrate preferably has a surface roughness (Rms) before the processing of 5 nm or lower.

In the method of processing a glass substrate surface of the invention, the processing technique is preferably gas cluster ion-beam etching.

In the method of processing a glass substrate surface of the invention, the gas cluster ion-beam etching preferably employs as a source gas a gas mixture selected from the group consisting of: a gas mixture comprising SF₆ and O₂; a gas mixture comprising SF₆, Ar, and O₂; a gas mixture comprising NF₃ and O₂; a gas mixture comprising NF₃, Ar, and C₂; a gas mixture comprising NF₃ and N₂; and a gas mixture comprising NF₃, Ar, and N₂.

It is more preferred to use a gas mixture comprising NF₃ and N₂ as the source gas.

In the method of processing a glass substrate surface of the invention, it is preferred that the method further comprise subjecting the glass substrate surface which has been processed by the foregoing method to a second processing for surface roughness improvement.

It is preferred that the second processing is gas cluster ion-beam etching using, as a source gas, either O₂ gas singly or a gas mixture comprising O₂ and at least one gas selected from the group consisting of Ar, CO, and CO₂ at an accelerating voltage of from 3 keV to less than 30 keV.

It is also preferred that the second processing is mechanical polishing with a polishing slurry at a surface pressure of 1-60 g_{f}/cm².

The invention further provides a frame to be arranged along the periphery of a glass substrate when a surface of the glass substrate is processed by the method of processing a glass substrate surface of the invention, the frame satisfying the following requirements (3) and (4):

(3) the difference between the height of the frame arranged along the periphery of the glass substrate and the height of the glass substrate surface is 1 mm or smaller; and

(4) the frame has a width of 1.5 mm or larger.

It is preferred that the frame of the invention is made of any member selected from the group consisting of a polyimide, an Ni—Cr alloy, beryllium, and single-crystal sapphire, or that the frame has a surface coated or plated with any member selected from that group.

The frame of the invention is preferably made of a quartz glass containing TiO₂.

The invention furthermore provides a glass substrate having a surface processed by the method of processing a glass substrate surface of the invention, the difference in flatness of the glass substrate surface between the central part and whole part of the glass substrate as defined below being 20 nm or smaller:

Central part: the area excluding the region having distances from the peripheral edge of up to 10 mm;

Whole part: the area excluding the region having distances from the peripheral edge of up to 5 mm (the whole part includes the central part).

According to the invention, the whole surface of a glass substrate can be processed into a surface excellent in flatness and surface roughness. In an EUVL mask blank produced from the glass substrate thus processed, the whole surface can be used as the exposure region for patterning. This is preferred from the standpoint of heightening the degree of integration of integrated circuits.

### BRIEF DESCRIPTION OF THE DRAWINGS

FIG. 1 is a slant view illustrating a glass substrate and one embodiment of the frame to be arranged along the periphery of the glass substrate.

FIG. 2 is a plan view illustrating the state in which the frame is arranged along the periphery of the glass substrate shown in FIG. 1.

FIG. 3 is a side view illustrating the state in which the frame is arranged along the periphery of the glass substrate shown in FIG. 1.

The reference numerals used in the drawings denote the following, respectively.
10: Glass substrate
12: Work surface
20: Frame
21: Opening
22: Frame element

### BEST MODE FOR CARRYING OUT THE INVENTION

The invention provides a method of processing a glass substrate surface using a processing technique selected from the group consisting of ion-beam etching, gas cluster ion-beam etching, plasma etching, and nano-ablation to give a surface excellent in flatness and surface roughness.

The processing method of the invention is suitable for the surface processing of a glass substrate for use as a reflective type mask for EUVL capable of coping with the trend toward higher degrees of integration and higher fineness in integrated circuits. The glass substrates for use in this application are glass substrates which have a low coefficient of thermal expansion and reduced variation of the coefficient. The glass substrates are preferably made of a low-expansion glass having a coefficient of thermal expansion at 20° C. or at 50-80° C. of from −30 to 30 ppb/° C., and more preferably made of an ultra-low-expansion glass having a coefficient of thermal expansion at 20° C. or at 50-80° C. of from −10 to 10 ppb/° C.

Most extensively used as such low-expansion glasses and ultra-low-expansion glasses are quartz glasses which comprise SiO₂ as the main component and contain a dopant so as to have a lower coefficient of thermal expansion. A typical example of such dopants incorporated into glasses for the purpose of lowering the coefficient of thermal expansion of the glasses is TiO₂. Specific examples of the quartz glasses containing TiO₂ as a dopant include ULE (registered trademark) Code 7972 (manufactured by Corning Glass Works).

The shape, size, thickness, etc. of the glass substrate are not particularly limited. However, in the case of a substrate for a reflective type mask for EUVL, the glass substrate is a platy material having a rectangular or square plane shape.

In the invention, since a processing technique selected from the group consisting of ion-beam etching, gas cluster ion-beam etching, plasma etching, and nano-ablation is used, a glass substrate surface can be processed so as to give a surface excellent in flatness and surface roughness. These processing techniques, however, are inferior to conventional mechanical polishing in processing rate, in particular, processing rate in the processing of a glass substrate surface having a large area. Because of this, the glass substrate surface may be preliminarily processed at a relatively high processing rate to a certain degree of flatness and surface roughness before being processed by the processing method of the invention.

Processing techniques usable for the preliminary processing are not particularly limited, and a suitable one can be selected from a wide range of known processing techniques for use in glass surface processing. However, a mechanical polishing technique is generally used because a surface having a large area can be polished at a time by using a polishing pad having a high processing rate and a large surface area. The term “mechanical polishing technique” herein includes not only a technique in which a surface is polished only by the polishing function of abrasive grains, but also includes a mechanochemical polishing technique in which the polishing function of abrasive grains and the chemical polishing function of a chemical are used in combination. The mechanical polishing technique may be either lapping or polishing, and the polishing tool(s) and abrasive material(s) to be used may be suitably selected from known ones.

In the case where preliminary processing is conducted, the surface roughness (Rms) of the glass substrate which has undergone the preliminary processing is preferably 5 nm or lower, more preferably 1 nm or lower. The term surface roughness as used in this specification means the surface roughness determined through an examination of an area of 1 to 10 μm square with an atomic force microscope. If the glass substrate which has been subjected to the preliminary processing has a surface roughness exceeding 5 nm, it will take considerable time to process this glass substrate surface to a predetermined flatness and a predetermined surface roughness by the processing method of the invention and this is a cause of cost increase.

The processing method of the invention is characterized in that before a glass substrate surface is processed using a processing technique selected from the group consisting of ion-beam etching, gas cluster ion-beam etching, plasma etching and nano-ablation, a frame element satisfying the following requirements (1) and (2) is arranged along the periphery of the glass substrate.

(1) The difference between the height of the frame element and the height of the glass substrate surface is 1 mm or smaller.

(2) The frame element has a width which is not smaller than one-half the beam diameter or laser light diameter to be used in the processing technique.

The arrangement of the frame element satisfying the requirements (1) and (2) along the periphery of the glass substrate can be accomplished by arranging a frame satisfying the following requirements (3) and (4) along the periphery of the glass substrate.

(3) The difference between the height of the frame arranged along the periphery of the glass substrate and the height of the glass substrate surface is 1 mm or smaller.

(4) The frame has a width of 1.5 mm or larger.

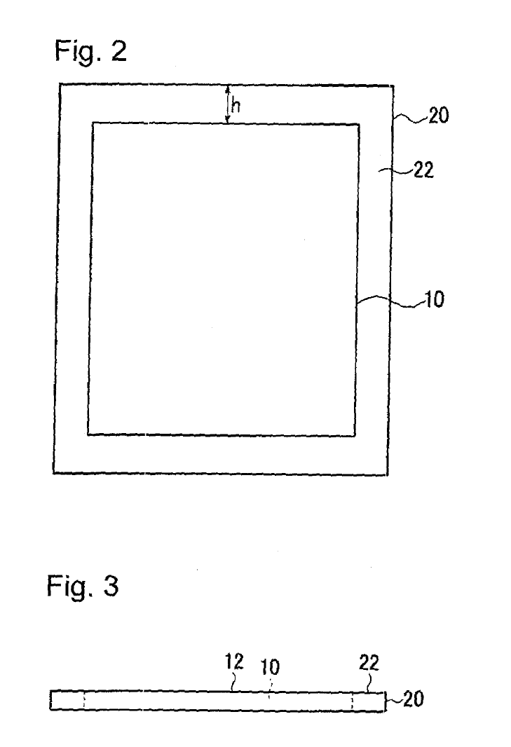

The “width of the frame” as referred to in the present invention is intended to mean the width of the frame element (e.g., the length indicated by “h” in FIG. 2). The regulation of the width of the frame to 1.5 mm or larger is for the purpose of securing mechanical strength of the frame. The diameter of the beam to be used in ion-beam etching, gas cluster ion-beam etching, and plasma etching and the diameter of the laser light to be used in nano-ablation can be reduced to a minimum value of about 3 mm in terms of FWHM (full width of half maximum). In this case, if the frame has a width of 1.5 mm or larger, then the width of the frame element is not smaller than one-half the diameter of the beam diameter or laser light diameter to be used in the processing technique.

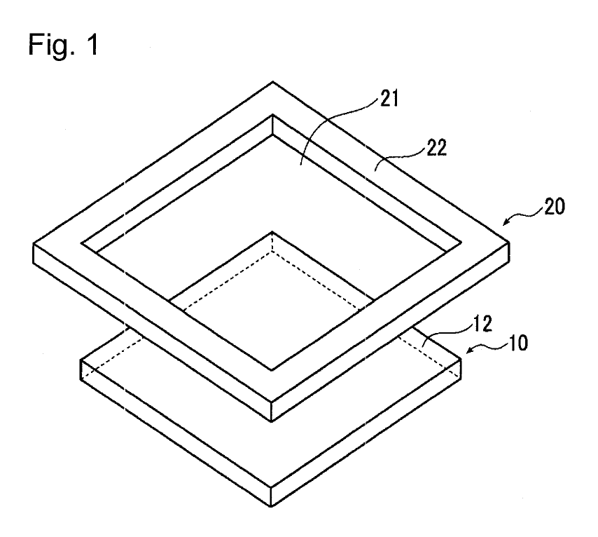

FIG. 1 is a slant view illustrating a glass substrate and one embodiment of the frame to be arranged along the periphery of the glass substrate. FIG. 2 and FIG. 3 are views illustrating the state in which the frame is arranged along the periphery of the glass substrate shown in FIG. 1; FIG. 2 is a plan view and FIG. 3 is a side view.

The frame 20 shown in FIG. 1 is a platy material having a rectangular plane shape (square in this case) and has a rectangular (square in this case) opening 21. The opening 21 is almost equal in size and shape to the surface to be processed 12 of the glass substrate 10 (hereinafter referred to as “work surface”). The expression “the frame is arranged along the periphery of the glass substrate 10 shown in FIG. 1” herein means to fit the glass substrate 10 into the opening 21 of the frame 20 as shown in FIG. 2. By fitting the glass substrate 10 into the opening 21 of the frame 20, the frame element 22 of the frame 20 is arranged along the periphery of the glass substrate 10, more specifically along the periphery of the work surface 12 of the glass substrate 10. Thus, the frame element 22 can be arranged along the periphery of the glass substrate 10, more specifically along the periphery of the work surface 12 of the glass substrate 10. In this state, the difference between the height of the work surface 12 of the glass substrate 10 and the height of the frame element 22 is 1 mm or smaller as shown in FIG. 3. Incidentally, in FIG. 3, the height of the work surface 12 is the same as the height of the frame element 22.

The space between the frame 20 and the glass substrate 10 is preferably not larger than one-half the beam diameter or laser light diameter. The reason for this is as follows. If the space between the frame 20 and the glass substrate 10 exceeds one-half the beam diameter or laser light diameter, the below-explained effect which is produced by arranging the frame 20 is considerably reduced, failing to uniformly process the whole work surface 12. As a result, the flatness becomes poor abruptly at the peripheral edge neighborhood of the work surface 12.

The frame 20 shown in FIGS. 1 to 3 is a platy material having a rectangular plane shape (square in this case) and having a rectangular (square in this case) opening 21. However, the shape of the frame is not limited thereto, and any desired shape can be appropriately selected according to the shape of the substrate around which the frame is to be arranged. For example, in the case where the peripheral edges of the glass substrate 10 have been beveled, it is preferred that the frame 20 has a shape capable of covering the beveled parts of the glass substrate 10. By covering the beveled parts of the glass substrate 10 with the frame 20, the height of the work surface 12 of the glass substrate 10 is made equal to that of the frame element 22.

The edges of the frame 20 that are on the side facing the glass substrate 10, specifically the edges on the same side as the work surface 12, may have been rounded off. The frame 20 having such a shape is expected to produce the following effect. Since the surface of the frame 20 that is in the vicinity of the work surface 12 is not perpendicular to the beam or laser light any longer, the surface (frame element 22) of the frame 20 that is in the vicinity of the work surface 12 becomes less apt to be processed at the time when the work surface 12 is processed. As a result, the trouble that foreign particles generated by the processing of the surface (frame element 22) of the frame 20 adhere to the work surface 12 to cause defects of the work surface 12 is inhibited.

The frame 20 shown in FIGS. 1 to 3 is a platy material of a monolithic structure having an opening 21. However, the frame 20 may have a divisible structure (e.g., a structure divisible into two or a structure divisible into four). For facilitating the operation of arranging the frame 20 along the periphery of the glass substrate 10, it is preferred that the frame 20 has a divisible structure.

The work surface 12 of the glass substrate 10 is processed using a processing technique selected from the group consisting of ion-beam etching, gas cluster ion-beam etching, plasma etching, and nano-ablation, with the frame element 22 arranged along the periphery of the work surface 12 as shown in FIGS. 2 and 3, whereby the whole work surface 12 can be uniformly processed.

If the work surface 12 of the glass substrate 10 is processed using a processing technique selected from the group consisting of ion-beam etching, gas cluster ion-beam etching, plasma etching, and nano-ablation without arranging the frame 20 along the periphery of the work surface, the work surface 12 cannot be uniformly processed over the whole surface, and the flatness becomes poor abruptly at the peripheral edge neighborhood of the work surface 12. This is because even when the whole work surface 12 is processed under the same conditions, the peripheral edge neighborhood of the work surface 12 (e.g., the region in the work surface 12 that has a distance from the peripheral edge of less than 10 mm) and the remaining area of the glass substrate (e.g., the region in the work surface 12 that has a distance from the peripheral edge of 10 mm and larger; this region is hereinafter referred to as “central part”) come to have a difference in processing rate.

The difference in processing rate between the peripheral edge neighborhood and the central part of the work surface 12 is thought to be attributable to the following reasons. In the processing technique in which the work surface 12 undergoes beam irradiation or laser light irradiation, such as ion-beam etching, gas cluster ion-beam etching, plasma etching, or nano-ablation, there arise differences between the peripheral edge neighborhood and the central part of the work surface 12, for example, in respect of the flowing manner of a source gas and the irradiation manner of a beam or laser light.

When the work surface 12 of the glass substrate 10 is processed using a processing technique selected from the group consisting of ion-beam etching, gas cluster ion-beam etching, plasma etching, and nano-ablation, with the frame element 22 arranged along the periphery of the work surface 12 as shown in FIGS. 2 and 3, then there is no difference in processing rate between the peripheral edge neighborhood and the central part of the work surface 12 and the whole work surface 12 can be uniformly processed. The reason for this is thought to be that the region which is irradiated with a beam or laser light is extended to the frame element 22 arranged along the periphery of the work surface 12, and this avoids the occurrences of the differences between the peripheral edge neighborhood and the central part of the work surface 12 in respect of the flowing manner of the source gas and the irradiation manner of the beam or laser light.

For this reason, the width h of the frame element 22 is preferably not smaller than one-half the beam diameter to be used in the ion-beam etching, gas cluster ion-beam etching or plasma etching, or not smaller than one-half the laser light diameter to be used in the nano-ablation. More preferably, the width h is not smaller than the beam diameter or laser light diameter.

The beam diameter to be used in the ion-beam etching, gas cluster ion-beam etching, and plasma etching and the laser light diameter to be used in the nano-ablation vary depending on the processing method and processing conditions to be used. However, from the standpoint of improving processing accuracy, the diameters are preferably 15 mm or smaller, more preferably 10 mm or smaller, further more preferably 5 mm or smaller, in terms of FWHM (full width of half maximum).

In the case where a processing technique employing a beam diameter or laser light diameter within the above-described range is used for processing a glass substrate surface, it is necessary to scan the glass substrate surface with the beam or laser light. For the scanning with the beam or laser light, a known technique such as, e.g., raster scanning or spiral scanning can be used.

The frame 20 is exposed to beam irradiation or laser light irradiation in the processing by a processing technique selected from the group consisting of ion-beam etching, gas cluster ion-beam etching, plasma etching, and nano-ablation. It is therefore preferred that the frame 20 is made of a material which is less apt to be processed by these processing techniques. In case where the frame 20 is made of a material which is readily processed by these processing techniques, there is a possibility that foreign particles generated by the processing of this frame 20 might adhere to the work surface 12 to cause defects to the work surface 12. From this standpoint, suitable materials for the frame 20 include polyimides, Ni—Cr alloys, beryllium, and single-crystal sapphire. Alternatively, the surface of the frame 20 may be coated or plated with any of these materials.

The problem posed by foreign particles generated by the processing of the frame 20 can be eliminated by producing the frame 20 from the same material as the glass substrate 10 to be processed, specifically the same low-expansion glass or ultra-low-expansion glass as the glass substrate 10, e.g., a quartz glass containing TiO₂.

In the invention, it is preferred to use gas cluster ion-beam etching among the processing techniques because this technique can give a surface having low surface roughness and excellent smoothness.

Gas cluster ion-beam etching is a technique in which one or more gaseous reactants (source gas) in a pressurized state are injected into a vacuum apparatus through an expansion nozzle at normal temperature and normal pressure to thereby form gas clusters, electronic irradiation is carried out thereon, and an ion beam of the resultant ionized gas clusters is caused to apply to and etch the object. A gas cluster is constituted by a mass of atoms or molecules generally composed of from several hundreds to several tens of thousands, preferably several thousands, of atoms or molecules. In the processing technique in the invention, when gas cluster ion-beam etching is used, collisions of gas clusters against the work surface 12 of the glass substrate 10 produce a multibody impact effect due to interaction with the solid, whereby the work surface 12 is processed.

### [Conditions of Gas Cluster Ion-Beam Etching]

In the case where gas cluster ion-beam etching is used, gases such as SF₆, Ar, O₂, N₂, NF₃, N₂O, CHF₃, CF₄, C₂F₆, C₃F₈, C₄F₆, SiF₄, and COF₂ can be used singly or as a mixture thereof as the source gas. Of these, SF₆ and NF₃ are superior as the source gas from the standpoint of chemical reactions occurring upon collision against the work surface 12 of the glass substrate 10. Because of this, gas mixtures containing SF₆ or NF₃ are preferred. Specifically, the following are preferred: a gas mixture comprising SF₆ and O₂; a gas mixture comprising SF₆, Ar, and O₂; a gas mixture comprising NF₃ and O₂; a gas mixture comprising NF₃, Ar, and O₂; a gas mixture comprising NF₃ and N₂; and a gas mixture comprising NF₃, Ar, and N₂. Although suitable mixing proportions of the respective component in these gas mixtures varies depending on conditions including irradiation conditions, the proportions are preferably as follows.

SF₆:O₂=(0.1-5%):(95-99.9%) (Gas mixture of SF₆ and O₂)

SF₆:Ar:O₂=(0.1-5%):(9.9-49.9%):(50-90%) (Gas mixture of SF₆, Ar, and O₂)

NF₃:O₂=(0.1-5%):(95-99.9%) (Gas mixture of NF₃ and O₂)

NF₃:Ar:O₂=(0.1-5%):(9.9-49.9%):(50-90%) (Gas mixture of NF₃, Ar, and O₂)

NF₃:N₂=(0.1-5%):(95-99.9%) (Gas mixture of NF₃ and N₂)

NF₃:Ar:N₂=(0.1-5%):(9.9-49.9%):(50-90%) (Gas mixture of NF₃, Ar, and N₂)

Of these gas mixtures, the gas mixture of NF₃ and N₂ is preferred because it has a relatively high etching rate.

Irradiation conditions including cluster size, the ionization current to be caused to flow through the ionization electrode of a gas cluster ion-beam etching apparatus in order to ionize clusters, the accelerating voltage to be applied to the acceleration electrode of the gas cluster ion-beam etching apparatus, and the dose of a gas cluster ion beam can be appropriately selected according to the kind of the source gas and the surface properties of the glass substrate. For example, for improving the flatness of the work surface 12 without excessively impairing surface roughness, the accelerating voltage to be applied to the acceleration electrode is preferably 15-30 keV.

According to the processing method of the invention, the whole work surface 12 can be uniformly processed without causing a difference in processing rate between the peripheral edge neighborhood and the central part of the work surface 12. As a result, in the glass substrate 10 thus processed, the central part and whole part of the work surface 12 as defined below have no difference in flatness. Specifically, the difference in flatness between the central part and whole part of the work surface 12 is 20 nm or smaller.

Central part: the area excluding the region having distances from the peripheral edge of up to 10 mm.

Whole part: the area excluding the region having distances from the peripheral edge of up to 5 mm. The whole part is an area including the central part.

In the glass substrate 10 which has been processed, the difference in flatness between the whole part and central part of the work surface 12 is preferably 10 nm or smaller, more preferably 5 nm or smaller.

The flatness of the work surface 12 can be determined with Zygo New View Series (Zygo Corp.) or SURF-COM (Tokyo Seimitsu Co., Ltd.).

When the work surface 12 of the glass substrate 10 is processed by the method described above, there are cases where the surface roughness of the work surface 12 is somewhat impaired depending on the state of the work surface 12 and beam or laser light irradiation conditions. For example, since the conditions of gas cluster ion-beam etching described in the foregoing [Conditions of Gas Cluster Ion-Beam Etching] section are conditions mainly for improving the flatness of the work surface 12, there may be cases where the surface roughness of the work surface 12 is somewhat impaired. Furthermore, there may be cases where a glass substrate cannot be processed to a desired surface roughness even through a desired flatness can be attained under the conditions described in the foregoing [Conditions of Gas Cluster Ion-Beam Etching] section, depending on the specification of the glass substrate.

For this reason, a second processing for improving the surface roughness of the work surface 12 of the glass substrate 10 may be further conducted in the invention after the work surface 12 has been processed by the method described above.

As the second processing intended for improving the surface roughness of the work surface 12, gas cluster ion-beam etching can be used. In this case, gas cluster ion-beam etching is conducted by changing the irradiation conditions including source gas, ionization current and accelerating voltage from those in the gas cluster ion-beam etching conducted above. Specifically, the gas cluster ion-beam etching herein is conducted under more moderate conditions, such as using a lower ionization current or a lower accelerating voltage. More specifically, the accelerating voltage is preferably from 3 keV to less than 30 keV, more preferably 3-20 keV. As for the source gas, it is preferred to use O₂ gas singly or a gas mixture comprising O₂ and at least one gas selected from the group consisting of Ar, CO and CO₂ because these gases are less apt to cause a chemical reaction upon collision against the work surface 12. Of these gases, it is preferred to use a gas mixture comprising O₂ and Ar.

As the second processing for improving the surface roughness of the work surface 12, the mechanical polishing called touch polishing can be conducted, in which a polishing slurry is used at a surface pressure as low as 1-60 g_{f}/cm². In the touch polishing, the glass substrate is set between polishing plates each having a polishing pad such as a nonwoven fabric or polishing fabric attached thereto, and the polishing plates are rotated relatively to the glass substrate while supplying a slurry adjusted so as to have predetermined properties, to thereby polish the work surface 12 at a surface pressure of 1-60 g_{f}/cm².

As the polishing pad, for example, Bellatrix K7512, manufactured by Kanebo, Ltd. is used. As the polishing slurry, it is preferred to use a polishing slurry containing colloidal silica. It is more preferred to use a polishing slurry which comprises colloidal silica having an average primary-particle diameter of 50 nm or smaller and water and which has a pH adjusted so as to be in the range of 0.5-4. The surface pressure upon the polishing is 1-60 g_{f}/cm². If the surface pressure exceeds 60 g_{f}/cm², this polishing causes scratches or the like in the substrate surface, failing to process the work surface 12 to a desired surface roughness. Further, there is a concern that the polishing plates might have an increased rotation load. If the surface pressure is lower than 1 g_{f}/cm², the processing requires a prolonged time period. Furthermore, when the surface pressure is lower than 30 g_{f}/cm², the processing requires much time. Therefore, it is preferred to process the work surface 12 at a surface pressure of 30-60 g_{f}/cm² up to some degree, and then carry out finish-polishing at a surface pressure of 1-30 g_{f}/cm².

The average primary-particle diameter of the colloidal silica is more preferably smaller than 20 nm, especially preferably smaller than 15 nm. There is no particular lower limit on the average primary-particle diameter of the colloidal silica. However, from the standpoint of improving polishing efficiency, the average primary-particle diameter thereof is preferably 5 nm or larger, more preferably 10 nm or larger. If the average primary-particle diameter of the colloidal silica exceeds 50 nm, it is difficult to process the work surface 12 so as to give a desired surface roughness. From the standpoint of strictly controlling the particle diameter, the colloidal silica desirably is one in which the content of secondary particles formed by the aggregation of primary particles is as low as possible. Even when the colloidal silica includes secondary particles, the average particle diameter of these particles is preferably 70 nm or smaller. The particle diameter of colloidal silica herein is one obtained through an examination of images having a magnification of (15-105)×10³ obtained with an SEM (scanning electron microscope).

The content of the colloidal silica in the polishing slurry is preferably 10-30% by mass. If the content of the colloidal silica in the polishing slurry is lower than 10% by mass, there is a concern that the efficiency of polishing might decrease, failing to attain economical polishing. On the other hand, if the content of the colloidal silica exceeds 30% by mass, the amount of the colloidal silica to be used increases and this may be disadvantageous from the standpoints of cost and washability. The content thereof is more preferably 18-25% by mass, especially preferably 18-22% by mass.

When the polishing slurry has a pH in the above-mentioned acid region, i.e., a pH in the range of 0.5-4, then the work surface 12 can be chemically and mechanically polished and can be efficiently polished so as to attain satisfactory smoothness. Namely, convex parts of the work surface 12 are softened by the acid contained in the polishing slurry and can hence be easily removed by the mechanical polishing. As a result, not only the efficiency of processing improves, but also waste glass particles removed by the polishing can be prevented from newly forming damages because such waste glass particles have been softened. If the pH of the polishing slurry is lower than 0.5, there is a concern that the polishing apparatus used for this touch polishing might corrode. From the standpoint of handleability of the polishing slurry, the pH thereof is preferably 1 or higher. In order for sufficiently obtaining the effect of chemical polishing, the pH of the slurry is preferably 4 or lower, especially in the range of 1.8-2.5.

The pH adjustment of the polishing slurry can be conducted by adding one acid or a combination of two or more acids selected from inorganic acids or organic acids. Examples of usable inorganic acids include nitric acid, sulfuric acid, hydrochloric acid, perchloric acid, and phosphoric acid. Nitric acid is preferred from the standpoint of handleability. Examples of the organic acids include oxalic acid and citric acid.

The water to be used in the polishing slurry is preferably pure water or ultrapure water from which foreign matters have been removed. Namely, it is preferred to use pure water or ultrapure water in which the number of fine particles having a major-axis length, as determined by the light-scattering method using a laser light or the like, of 0.1 μm or larger is substantially not larger than one per mL. Use of water containing more than one such foreign particle per mL may cause surface defects such as scratches and pits to the work surface 12, irrespective of the material and shape of the foreign particles. Foreign particles present in pure water or ultrapure water can be removed, for example, by filtration or ultrafiltration through a membrane filter. However, the method for removing foreign particles is not limited to these.

In the glass substrate 10 which has been processed by the processing method of the invention, the whole work surface 12 is excellent in flatness and surface roughness. The glass substrate 10 is hence suitable for use as an optical element in the optical system of an exposure tool for semiconductor device production. In particular, the processed glass substrate 10 is suitable for use as an optical element in the optical system of an exposure tool for producing next-generation semiconductor devices having a line width of 45 nm or smaller. Examples of such optical elements include lenses, diffraction gratings, optical film materials, and combinations of these. Specifically, the examples include lenses, multilenses, lens arrays, lenticular lenses, fly-eye lenses, aspherical lenses, mirrors, diffraction gratings, binary optics elements, photomasks, and combinations of these.

Furthermore, since the glass substrate 10 which has been processed by the processing method of the invention is excellent in the flatness and surface roughness of the whole work surface 12, the glass substrate 10 is suitable for use as a photomask or as a mask blank for producing the photomask. In particular, the processed glass substrate 10 is suitable for use as a reflective type mask for EUVL and as a mask blank for producing the mask.

Although the light source of the exposure tool is not particularly limited, and may be a laser which emits g-line (wavelength, 436 nm) or i-line (wavelength, 365 nm), which have been used hitherto, a light source having a shorter wavelength, e.g., a light source having a wavelength of 250 nm or shorter, is preferred. Specific examples of such light sources include a KrF excimer laser (wavelength, 248 nm), ArF excimer laser (wavelength, 193 nm), F₂ laser (wavelength, 157 nm), and EUV (13.5 nm).

### EXAMPLES

The invention will be illustrated in greater detail with reference to the following Example, but the invention should not be construed as being limited thereto.

### Example

A 152-mm square glass substrate made of a low-expansion glass (TiO₂-containing quartz glass substrate) was prepared and preliminarily processed by mechanical polishing to a flatness of 268 nm (value of flatness of the whole part defined above) and a surface roughness of 0.11 nm. A frame 20 was arranged along the periphery of the preliminarily processed glass substrate 10 in the manner as shown in FIGS. 1 to 3. The work surface 12 of the glass substrate 10 in this state was processed by gas cluster ion-beam etching. The frame 20 used was made of the same low-expansion glass (TiO₂-containing quartz glass) as the glass substrate 10, and the width h of the frame element 22 was 5 mm. Conditions of the gas cluster ion-beam etching were as follows.

Source gas: gas mixture of 5% NF₃ and 95% N₂ (vol %)

Accelerating voltage: 30 keV

Cluster size: 1,000 or larger

Beam current: 100 μA

Beam diameter (FWHM value): 4.5 mm or smaller

Processing time: 50 minutes

The 152-mm square work surface 12 was scanned with a beam so that the whole work surface 12 was irradiated with the beam while controlling the dose by controlling the scanning speed.

### Comparative Example

The work surface of a glass substrate was processed by gas cluster ion-beam etching by the same procedure as in the Example, except that the disposition of a frame along the periphery of the glass substrate was omitted.

With respect to each of Example and Comparative Example, the flatness of each of the central part and whole part of the work surface 12 after the processing was measured. The central part and the whole part are as defined above. The results of the flatness measurement are shown below.

### Example

Flatness (central part): 81 nm

Flatness (whole part): 89 nm

### Comparative Example

Flatness (central part): 78 nm

Flatness (whole part): 116 nm

While the present invention has been described in detail and with reference to specific embodiments thereof, it will be apparent to one skilled in the art that various changes and modifications can be made therein without departing from the spirit and scope thereof.

This application is based on Japanese Patent Application No. 2007-148752 filed Jun. 5, 2007, and the contents thereof are herein incorporated by reference.

1. A method of processing a glass substrate surface by a processing technique selected from the group consisting of ion-beam etching, gas cluster ion-beam etching, plasma etching, and nano-ablation,
wherein a frame element satisfying the following requirements (1) and (2) is arranged along the periphery of the glass substrate before the glass substrate surface is processed:
(1) the difference between the height of the frame element and the height of the glass substrate surface is 1 mm or smaller; and
(2) the frame element has a width which is not smaller than one-half the beam diameter or laser light diameter to be used in the processing technique.

2. The method of processing a glass substrate surface according to claim 1, wherein the glass substrate is made of a low-expansion glass having a coefficient of thermal expansion at 20° C. or at 50-80° C. of from −30 to 30 ppb/° C.

3. The method of processing a glass substrate surface according to claim 1, wherein the frame element is made of the same glass material as the glass substrate to be processed.

4. The method of processing a glass substrate surface according to claim 1, wherein the frame element is made of any member selected from the group consisting of a polyimide, an Ni—Cr alloy, beryllium, and single-crystal sapphire, or the frame element has a surface coated or plated with any member selected from said group.

5. The method of processing a glass substrate surface according to claim 1, wherein the glass substrate has a surface roughness (Rms) before the processing of 5 nm or lower.

6. The method of processing a glass substrate surface according to claim 1, wherein the processing technique is gas cluster ion-beam etching.

7. The method of processing a glass substrate surface according to claim 6, wherein the gas cluster ion-beam etching employs, as a source gas, a gas mixture selected from the group consisting of: a gas mixture comprising SF₆ and O₂; a gas mixture comprising SF₆, Ar, and O₂; a gas mixture comprising NF₃ and O₂; a gas mixture comprising NF₃, Ar, and O₂; a gas mixture comprising NF₃ and N₂; and a gas mixture comprising NF₃, Ar, and N₂.

8. The method of processing a glass substrate surface according to claim 7, wherein the source gas is a gas mixture comprising NF₃ and N₂.

9. The method of processing a glass substrate surface according to claim 1, further comprising subjecting the processed glass substrate surface to a second processing for surface roughness improvement.

10. The method of processing a glass substrate surface according to claim 9, wherein the second processing is gas cluster ion-beam etching using, as a source gas, either O₂ gas singly or a gas mixture comprising O₂ and at least one gas selected from the group consisting of Ar, CO, and CO₂ at an accelerating voltage of from 3 keV to less than 30 keV.

11. The method of processing a glass substrate surface according to claim 9, wherein the second processing is mechanical polishing with a polishing slurry at a surface pressure of 1-60 g_{f}/cm².

12. A frame to be arranged along the periphery of a glass substrate when a surface of the glass substrate is processed by the method of processing a glass substrate surface according to claim 1, the frame satisfying the following requirements (3) and (4):
(3) the difference between the height of the frame arranged along the periphery of the glass substrate and the height of the glass substrate surface is 1 mm or smaller; and
(4) the frame has a width of 1.5 mm or larger.

13. The frame according to claim 13, wherein the frame is made of any member selected from the group consisting of a polyimide, an Ni—Cr alloy, beryllium, and single-crystal sapphire, or the frame has a surface coated or plated with any member selected from said group.

14. The frame according to claim 12, being made of a quartz glass containing TiO₂.

15. A glass substrate having a surface processed by the method according to claim 1, the difference in flatness of the glass substrate surface between the central part and whole part of the glass substrate as defined below being 20 nm or smaller:
Central part: the area excluding the region having distances from the peripheral edge of up to 10 mm;
Whole part: the area excluding the region having distances from the peripheral edge of up to 5 mm (the whole part includes the central part).
